(19) United States
(12) Patent Application Publication
(10) Pub. No.: US 2025/0285050 A1
(43) Pub. Date: Sep. 11, 2025

(54) SYSTEM AND METHOD FOR PREDICTING A SHRINKAGE PERCENTAGE IN A TIME-SLOT DURING A FUTURE STAFFING PLAN IN A CONTACT CENTER

(71) Applicant: NICE LTD., Ra'anana (IL)

(72) Inventors: Vaibhav CHOBE, Pune (IN); Niranjan BAGADE, Pune (IN)

(21) Appl. No.: 18/596,697

(22) Filed: Mar. 6, 2024

(51) Int. Cl. G06Q 10/0631

(52) U.S. Cl. CPC G06Q 10/063118

(57) ABSTRACT

A computerized-method for predicting a staffing-shrinkage percentage in a time-slot during a future staffing plan in a contact center, The computerized-method includes: (i) receiving via a User Interface that is associated to a Workforce Management (WFM) application, skills for the future staffing plan and the time-slot; (ii) calculating a historic-shrinkage percentage during a preconfigured period based on agents time-offs and understaffing-levels during the preconfigured period; (iii) determining the staffing-shrinkage percentage in the time-slot during the future staffing plan based on the calculated historic-shrinkage percentage; and (iv) configuring the WFM application to update staffing level in the future staffing plan, based on the determined staffing-shrinkage percentage.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of data analysis and more specifically, to computerized systems and methods for predicting a shrinkage percentage in a time-slot during a future staffing plan in a contact center.

### BACKGROUND

In contact centers, Workforce Management (WFM) application is used for generating a staffing plan based on a generated forecast. The forecast generation process ensures that the contact center has the right number of agents available to handle customer interactions while meeting service level targets. Staffing-shrinkage is an essential factor in the process of generating a staffing plan for forecast generation, as it provides information as to the time that agents are not available to handle customer contacts due to various reasons.

Various problems may arise when the determined staffing-shrinkage is not accurate, such as understaffing, overstaffing inaccurate forecasts, adherence issues, inadequate resource planning, and inability to optimize scheduling. Without proper staffing-shrinkage considerations, the staffing plan may not allocate enough agents to cover periods when staffing-shrinkage is high, which may result in understaffing. Staffing-shrinkage includes factors, such as breaks, meetings, training, vacations, and other non-productive activities, and ignoring these factors may result in understaffing, which means there are not enough agents available to handle the incoming workload. When there are not enough agents available to handle the incoming workload customer service levels may drop, leading to frustrated customers and potential revenue loss.

Conversely, if staffing-shrinkage is not considered or miscalculated, it might lead to overstaffing. Overstaffing is inefficient and costly since it means the organization is paying for more agents than necessary which may result in increased labor costs, decreased profitability, and wasted resources.

Staffing-shrinkage plays a crucial role in refining the forecast accuracy. If it is ignored or calculated incorrectly, the forecast itself may be inaccurate. Accurate staffing-shrinkage adjustments to the staffing plan may help create a more precise picture of the actual number of agents required to handle customer demand.

Staffing-shrinkage is also a factor used to monitor agent adherence to their assigned schedules. Adherence compares the actual time an agent spends handling contacts to their scheduled work time. Without proper staffing-shrinkage calculations, it becomes difficult to determine whether agents are adhering to their schedules effectively, leading to potential productivity and performance problems.

Workforce managers use staffing-shrinkage data to plan and allocate resources effectively. They use this information to determine the ideal number of agents required for different time intervals throughout the day. Incorrect or missing staffing-shrinkage data can result in misallocated resources, causing service level gaps during peak demand periods.

Staffing-shrinkage data is also important in optimizing agent schedules. Without it, it becomes challenging to create schedules that maximize agent utilization and ensure the right coverage during high-demand periods.

Accordingly, there is a need for a technical solution for predicting a staffing-shrinkage percentage in a time-slot during a future staffing plan in a contact center and then updating the staffing level in the future staffing plan based on the staffing-shrinkage percentage.

### SUMMARY

There is thus provided, in accordance with some embodiments of the present disclosure, a computerized-method for predicting a staffing-shrinkage percentage in a time-slot during a future staffing plan in a contact center.

In accordance with some embodiments of the present disclosure, the computerized-method may include: (i) receiving via a User Interface that is associated to a Workforce Management (WFM) application, one or more skills for the future staffing plan and the time-slot; (ii) calculating a historic-shrinkage percentage during a preconfigured period based on agents time-offs and understaffing-levels during the preconfigured period; (iii) determining the staffing-shrinkage percentage in the time-slot during the future staffing plan based on the calculated historic-shrinkage percentage; and (iv) configuring the WFM application to update staffing level in the future staffing plan, based on the determined staffing-shrinkage percentage and store the updated future staffing plan in a WFM database.

Furthermore, in accordance with some embodiments of the present disclosure, the calculating of the historic-shrinkage percentage during the preconfigured period may include: (i) calculating a staffing-shrinkage percentage of agents-level by: a. retrieving agents time-offs during the preconfigured period from a schedule-change-request database; b. filtering the retrieved agents time-offs based on the received one or more skills of corresponding agents and the time-off; and c. calculating a mean of agents that took time-offs in the time-slot by identifying a total number of agents in the filtered agents time-offs and then dividing the identified total number of agents by a total number of time-slots in the filtered agents time-offs to yield an agent-level-shrinkage; (ii) calculating a staffing-shrinkage percentage of net-staffing level by: a. retrieving net-staffing data of a plurality of staffing plans during the preconfigured period, from staffing-data database; b. filtering the plurality of staffing plans based on the one or more skills of corresponding agents and understaffed time-slots in the time-slot; and c.

calculating a mean of understaffed time-slots by identifying a number of understaffed time-slots for the time-slot in the filtered plurality of staffing plans and then dividing a sum of understaffed-agents in all the identified number of understaffed time-slots by the total number of time-slots to yield a net-staffing-level-shrinkage; and (iii) determining the historic-shrinkage percentage during the preconfigured period by calculating a mean of the agent-level-shrinkage and the net-staffing-level-shrinkage.

Furthermore, in accordance with some embodiments of the present disclosure, the determined staffing-shrinkage percentage may be presented as a message via the UI that is associated to the WFM application by operating a Generative Artificial Intelligence AI (GenAI) service with a prompt to yield the message.

Furthermore, in accordance with some embodiments of the present disclosure, the operating of the GenAI service may be performed by generating a prompt by embedding the determined staffing-shrinkage percentage in a prompt-template and then executing the GenAI with the prompt.

Furthermore, in accordance with some embodiments of the present disclosure, the updating of the staffing level of the future staffing plan, based on the determined staffing-shrinkage percentage may be performed by adding number of agents to the future staffing plan.

There is further provided, in accordance with some embodiments of the present invention, a computerized-system for predicting a staffing-shrinkage percentage in a time-slot during a future staffing plan in a contact center.

Furthermore, in accordance with some embodiments of the present disclosure, the computerized-system includes one or more processors and a WFM database. The one or more processors may be configured to: (i) receive via a User Interface that is associated to a Workforce Management (WFM) application, one or more skills for the future staffing plan and the time-slot; (ii) calculate a historic-shrinkage percentage during a preconfigured period based on agents time-offs and understaffing-levels during the preconfigured period; (iii) determine the staffing-shrinkage percentage in the time-slot during the future staffing plan based on the calculated historic-shrinkage percentage; and (iv) configure the WFM application to update staffing level in the future staffing plan, based on the determined staffing-shrinkage percentage and store the updated future staffing plan in the WFM database.

Furthermore, in accordance with some embodiments of the present disclosure, the calculating of the historic-shrinkage percentage during the preconfigured period may include: (i) calculating a staffing-shrinkage percentage of agents-level by: a. retrieving agents time-offs during the preconfigured period from a schedule-change-request database; b. filtering the retrieved agents time-offs based on the received one or more skills of corresponding agents and the time-off; and c. calculating a mean of agents that took time-offs in the time-slot by identifying a total number of agents in the filtered agents time-offs and then dividing the identified total number of agents by a total number of time-slots in the filtered agents time-offs to yield an agent-level-shrinkage; (ii) calculating a staffing-shrinkage percentage of net-staffing level by: a. retrieving net-staffing data of a plurality of staffing plans during the preconfigured period, from staffing-data database; b. filtering the plurality of staffing plans based on the one or more skills of corresponding agents and understaffed time-slots in the time-slot; and c.

calculating a mean of understaffed time-slots by identifying a number of understaffed time-slots for the time-slot in the filtered plurality of staffing plans and then dividing a sum of understaffed-agents in all the identified number of understaffed time-slots by the total number of time-slots to yield a net-staffing-level-shrinkage; and (iii) determining the historic-shrinkage percentage during the preconfigured period by calculating a mean of the agent-level-shrinkage and the net-staffing-level-shrinkage.

Furthermore, in accordance with some embodiments of the present disclosure, the determined staffing-shrinkage percentage may be presented as a message via the UI that is associated to the WFM application by operating a Generative Artificial Intelligence AI (GenAI) service with a prompt to yield the message.

Furthermore, in accordance with some embodiments of the present disclosure, the operating of the GenAI service may be performed by generating a prompt by embedding the determined staffing-shrinkage percentage in a prompt-template and then executing the GenAI with the prompt.

Furthermore, in accordance with some embodiments of the present disclosure, the updating of the staffing level of the future staffing plan, based on the determined staffing-shrinkage percentage may be performed by adding number of agents to the future staffing plan.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIGS. 1A-1C schematically illustrates a high-level diagram of a computerized-system for predicting a staffing-shrinkage percentage in a time-slot during a future staffing plan in a contact center, in accordance with some embodiments of the present invention;

FIG. 2 schematically illustrates a high-level diagram of a computerized-method for predicting a staffing-shrinkage percentage in a time-slot during a future staffing plan in a contact center, in accordance with some embodiments of the present invention;

FIGS. 3A-3B are a high-level workflow of predicting a staffing-shrinkage percentage in a time-slot during a future staffing plan, in accordance with some embodiments of the present invention;

FIGS. 4A-4B are screenshots of UI for staffing staffing-shrinkage parameter of a WFM application, in accordance with some embodiments of the present invention; and

FIG. 5 is a high-level workflow of interaction with GenAI for predicting a staffing-shrinkage percentage in a time-slot during a future staffing plan, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

There is a need for a technical solution to provide a predicted staffing shrinkage percentage based on historic time-off reports of agents and net-staffing data of a specific time-slot.

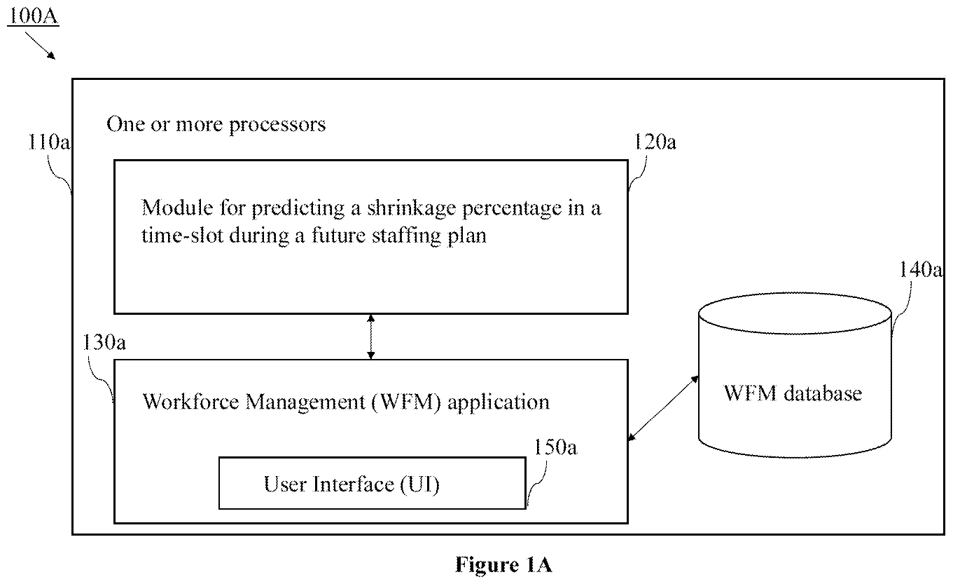

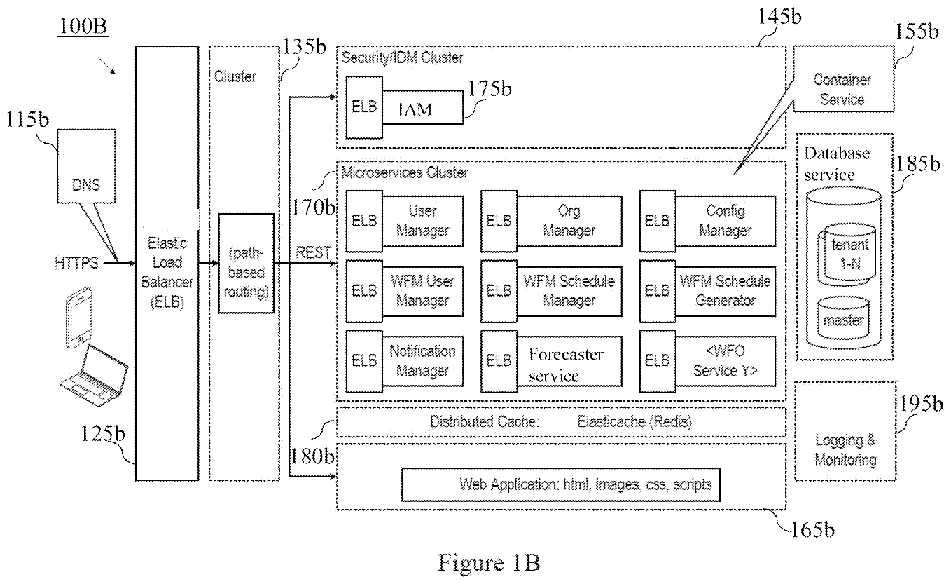

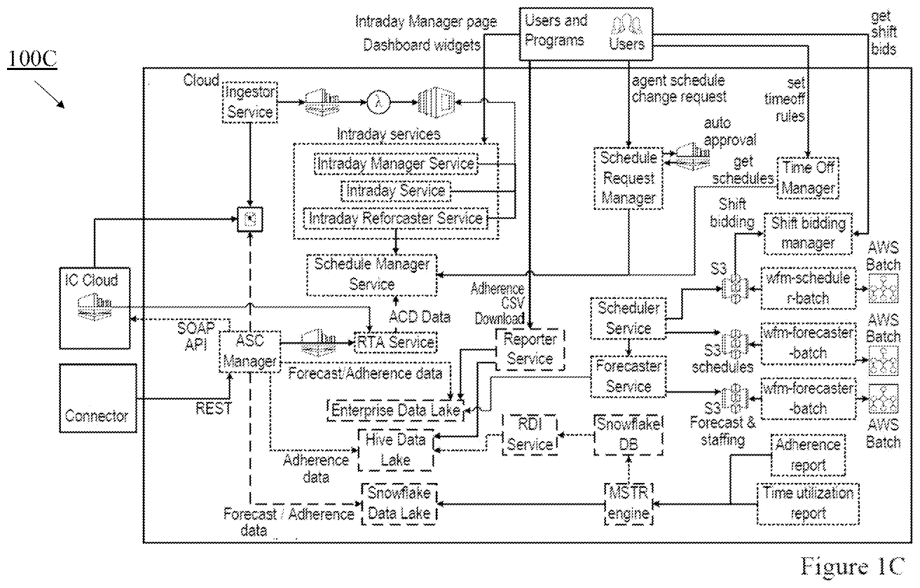

FIG. 1A schematically illustrates a high-level diagram of a computerized-system 100A for predicting a staffing-shrinkage percentage in a time-slot during a future staffing plan in a contact center, in accordance with some embodiments of the present invention.

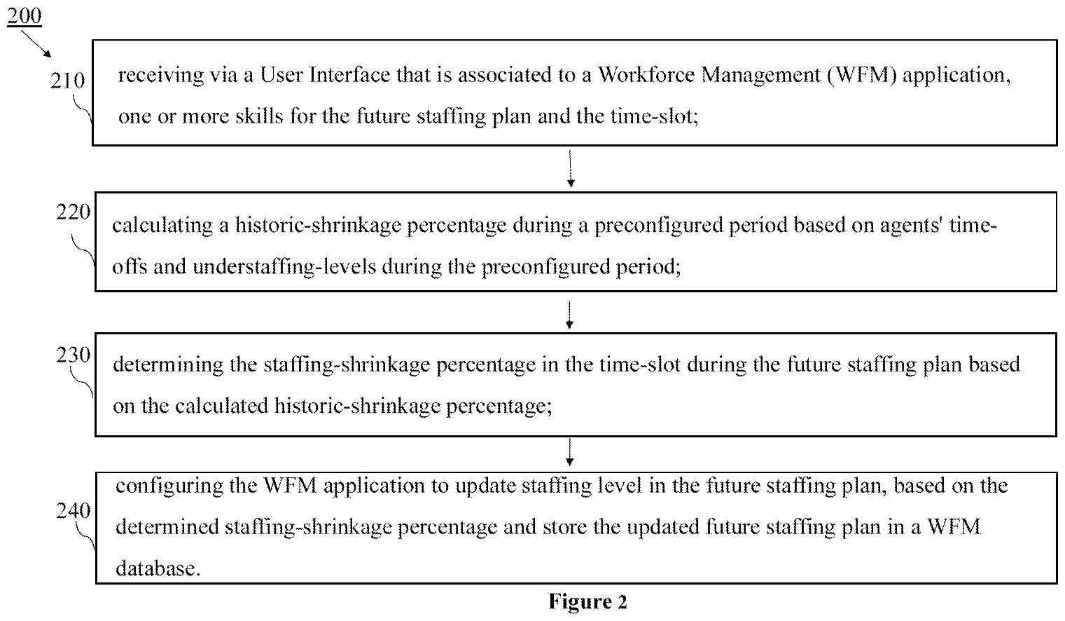

According to some embodiments of the present disclosure, a system such as system 100A may provide a predicted staffing-shrinkage percentage in a time-slot during a future staffing plan in a contact center by implementing a computerized-method, such as computerized-method 200 in FIG. 2 for predicting a staffing-shrinkage percentage in a time-slot during a future staffing plan in a contact center.

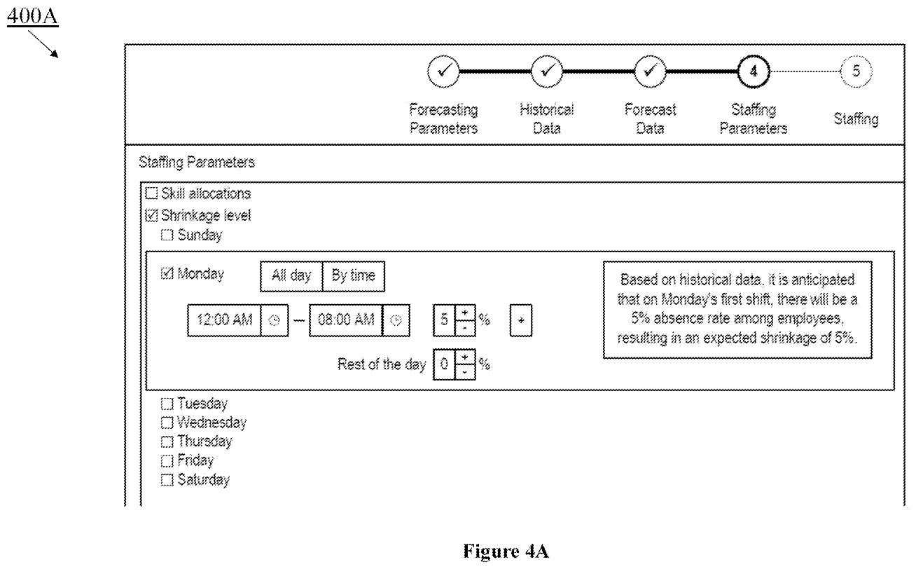

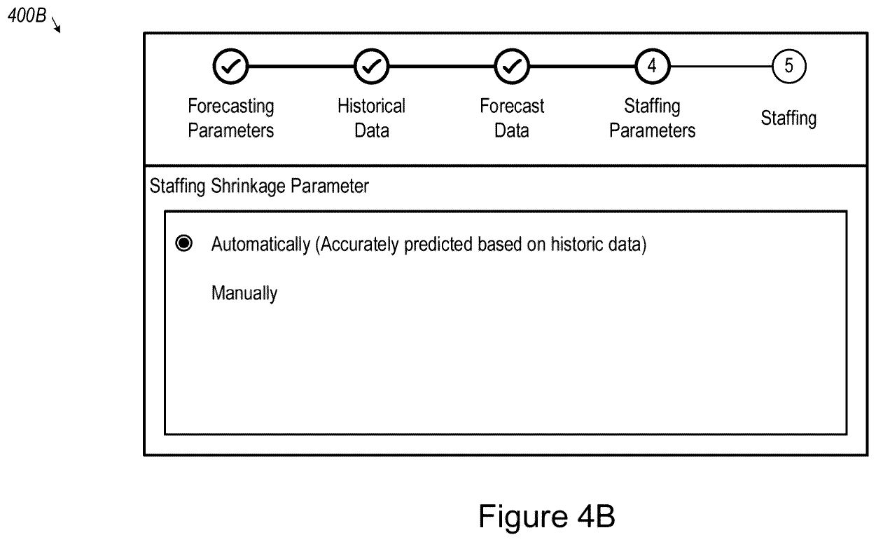

According to some embodiments of the present disclosure, system 100A may receive via a User Interface (UI) 150a, such as UI 400a in FIG. 4A, that is associated to a Workforce Management (WFM) application 130a, skills for future staffing plan and a time-slot for staffing-shrinkage prediction. For example, the skills may be English as mother-tongue and credit card for Monday between 12:00 AM-8:00 AM.

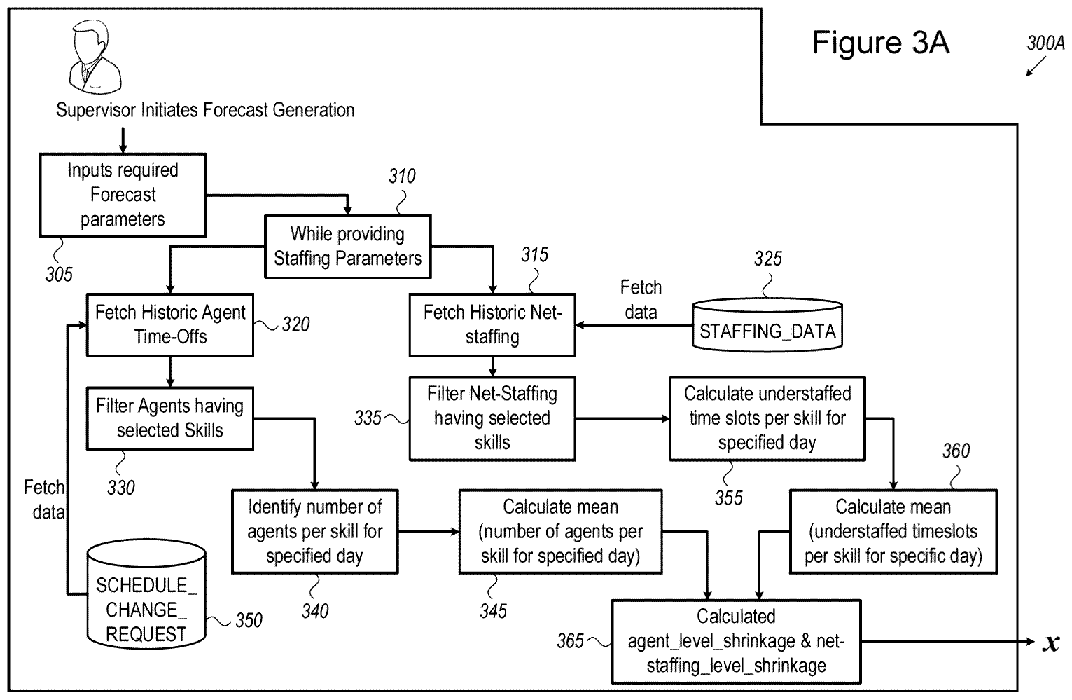

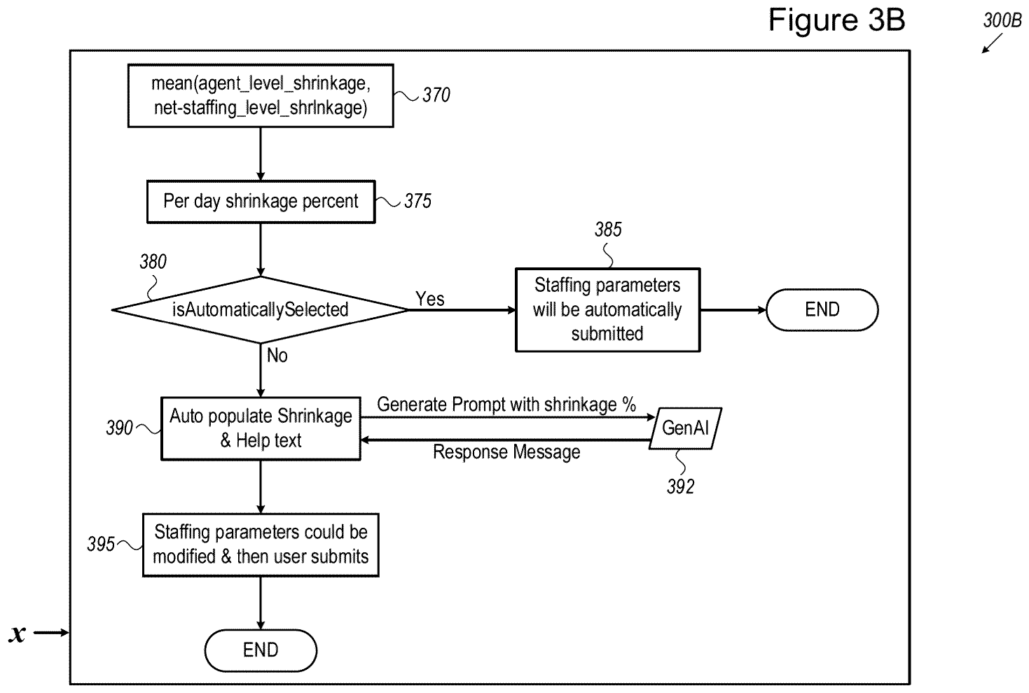

According to some embodiments of the present disclosure, a historic-shrinkage percentage during a preconfigured period based on agents time-offs and understaffing-levels during the preconfigured period may be calculated. The calculation of the historic-shrinkage percentage may be performed by calculating a mean of a calculated shrinkage percentage of agents-level and a calculated net-staffing level, for example as shown in FIG. 3A.

According to some embodiments of the present disclosure, the calculation of the shrinkage percentage of agents-level may be performed by a module, such as module for predicting a shrinkage percentage in a time-slot during a future staffing plan 120a by retrieving agents time-offs during the preconfigured period from a schedule-change-request database and then filtering the retrieved agents time-offs based on the received one or more skills of corresponding agents and the time-off, and then calculating a mean of agents that took time-offs in the time-slot by identifying a total number of agents in the filtered agents time-offs and then dividing the identified total number of agents by a total number of time-slots in the filtered agents time-offs to yield an agent-level-shrinkage.

According to some embodiments of the present disclosure, the calculation of the shrinkage percentage of net-staffing level may be performed by retrieving net-staffing data of a plurality of staffing plans during the preconfigured period, from a staffing-data database, and then filtering the plurality of staffing plans based on the one or more skills of corresponding agents and understaffed time-slots in the time-slot. The net-staffing-level-shrinkage may be a calculated mean of understaffed time-slots. The mean of the understaffed time-slots may be calculated by identifying a number of understaffed time-slots for the time-slot in the filtered plurality of staffing plans and then dividing a sum of understaffed-agents in all the identified number of understaffed time-slots by the total number of time-slots.

According to some embodiments of the present disclosure, the staffing-shrinkage percentage may be presented as a message via the UI 150a that is associated to the WFM application 130a, for example, as shown in FIG. 4A, by operating a Generative Artificial Intelligence AI (GenAI) service with a prompt to yield the message.

According to some embodiments of the present disclosure, the WFM application 130a may be configured to update the staffing level in the future staffing plan based on the determined staffing-shrinkage percentage and store the updated future staffing plan in the WFM database 140a.

According to some embodiments of the present disclosure, the updating of the staffing level of the future staffing plan, based on the determined staffing-shrinkage percentage may be performed by adding number of agents to the future staffing plan. The number of added agents may be calculated by the determined staffing-shrinkage percentage from the total agents which have the skills and are scheduled to the time-slot. For example: for skill English as mother-tongue for which original required number of agents was 100 agents on Monday and the determined staffing-shrinkage percentage by the module for predicting a shrinkage percentage in a time-slot during a future staffing plan 120a for Monday for the time-slot 12:00 AM-8:00 AM is 10%, then the updated number of agents on Monday may be calculated by: 100+10%*100=110.

According to some embodiments of the present disclosure, system 100A introduces automation, information transparency, and user control into the forecasting process, specifically focusing on staffing parameters and staffing-shrinkage levels. The integration of GenAI and the option for manual override by users adds flexibility and adaptability to the system, ensuring a balance between automated efficiency and human expertise.

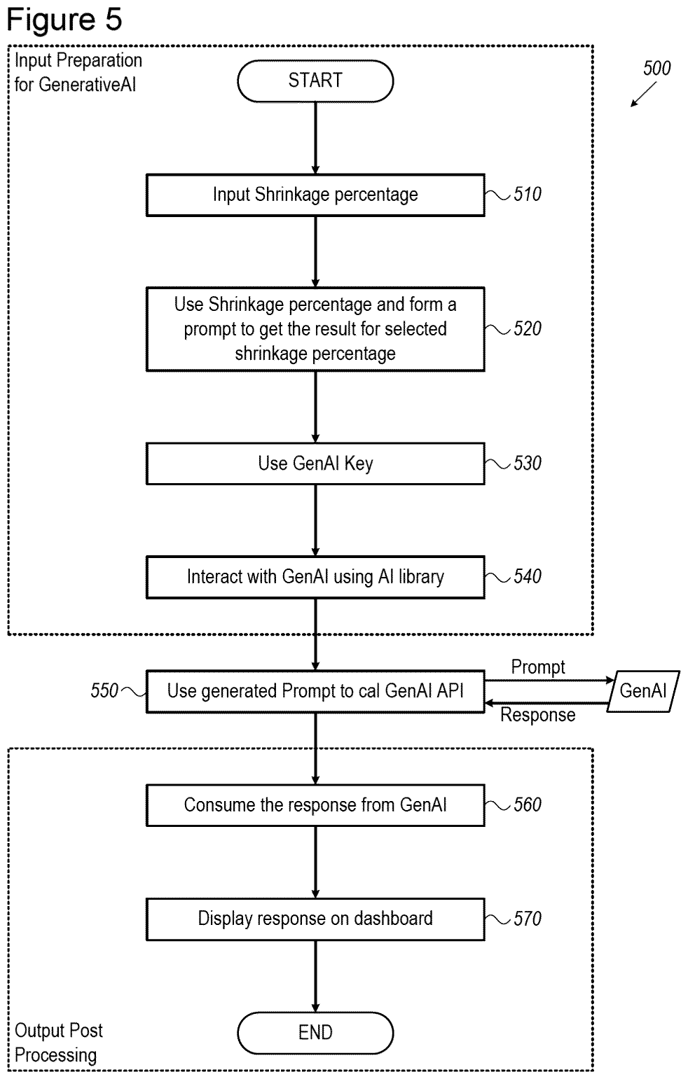

According to some embodiments of the present disclosure, system 100A may receive from a user an input shrinkage percentage, for example via a UI of the WFM application, as shown in FIG. 4A and then may generate a prompt for Gen AI. It may call the Gen AI API with the raw input, and may receive an intuitive suggestion from the Gen AI, to be displayed as a suggestion to the supervisor. The use of a unique key ensures secure and authorized access to Gen AI services, as shown in FIG. 5.

According to some embodiments of the present disclosure, system 100 may be implemented in system 100B in FIG. 1B and in system 100C in FIG. 1C, as part of the forecaster service.

FIG. 1B schematically illustrates a high-level diagram of a computerized-system 100B for predicting a staffing-shrinkage percentage in a time-slot during a future staffing plan in a contact center, in accordance with some embodiments of the present invention.

According to some embodiments of the present disclosure, system 100B may include similar components as system 100A in FIG. 1A. The building blocks of the WFM application infrastructure, such as WFM application 130a in FIG. 1A, may be implemented by the following components.

According to some embodiments of the present disclosure, the operation of the WFM application, such as WFM application 130a in FIG. 1A, may include a scalable cloud Domain Name System (DNS) service, path-based routing, a cloud object storage with scalability, a Content Delivery Network (CDN) service, an open-source Identity and Access Management (IAM) tool and other components.

According to some embodiments of the present disclosure, the scalable cloud DNS service, which enables to customize DNS routing policies to reduce latency 115b, for example, such as Amazon Route 53 Resolver may respond recursively to DNS queries from Amazon Web Services (AWS) resources for public records, Amazon Virtual Private Cloud (VPC)-specific DNS names, and Amazon Route 53 private hosted zones.

According to some embodiments of the present disclosure, the Elastic Load balancer (ELB) 125b may automatically distribute incoming traffic across multiple targets, such as EC2 instances, containers, and IP addresses, in one or more availability zones. It monitors the health of its registered targets, and routes traffic only to the healthy targets. Elastic Load Balancing scales the load balancer as incoming traffic changes over time. It can automatically scale to most workloads.

According to some embodiments of the present disclosure, path-based routing 135b, via an open-source web server software used for reverse proxy, load balancing, and email proxy, and Hypertext Transfer Protocol Secure (HTTP) cache to provide HTTPS server capabilities, such as NGINX.

According to some embodiments of the present disclosure, the Security/Identity Management (IDM) cluster 145b is part of security where IDM is responsible for ensuring that only authorized users are granted access to specific applications, components, and systems.

According to some embodiments of the present disclosure, the container service 155b is a package that holds an application and dependencies, libraries, and the like, that the application requires to run. Containers are independent of the underlying operating system and hence container applications are fairly portable, flexible, and scalable. This ensures the application will run always as expected irrespective of the system and environment in which a container is running.

According to some embodiments of the present disclosure, a cloud object storage with scalability, data availability, security, and performance 165b, such as Amazon S3, may be used to store data as objects within buckets. An object is a file and any metadata that describes the file. A bucket is a container for objects. To store data in Amazon S3, a bucket may be created.

According to some embodiments of the present disclosure, the CDN service built for high performance, security, and developer convenience, such as CloudFront CDN that is a CDN service operated by Amazon Web Services. It's designed to provide a globally-distributed network of proxy servers to cache content, such as web videos or other bulky media, more locally to consumers.

According to some embodiments of the present disclosure, an open-source IAM tool 175b, such as Keycloak, may provide Single Sign-On (SSO) access to applications and services. It enables users to authenticate once and access multiple applications without needing to re-enter their credentials.

According to some embodiments of the present disclosure, database service 185b provides a collection of managed services to set up, operate, and scale databases in the cloud. For example, Amazon Relational Database Service (RDS) is a web service offered by Amazon Web Services (AWS). It is a managed SQL database service that helps with relational database management tasks, such as data migration, backup, recovery, and patching. For example, the WFM database 140a in FIG. 1A may be implemented by database service 185b.

According to some embodiments of the present disclosure, a monitoring service 195b built for DevOps engineers, developers, site reliability engineers (SREs), Information Technology (IT) managers, and product owners, such as AWS CloudWatch may monitor and manage AWS resources and applications. It may collect and track metrics that measure resources and applications.

According to some embodiments of the present disclosure, a container service 155b, which may include a forecaster service. The forecaster service may operate a system, such as system 100A in FIG. 1A to predict a staffing-shrinkage percentage in a time-slot during a future staffing plan in the contact center. The container service 155b in the microservice cluster 170b, may be for example, Amazon ECS cluster is a logical grouping of tasks or services. In addition to tasks and services, a cluster consists of the following resources: the infrastructure capacity which can be a combination of the following: Amazon EC2 instances in the AWS cloud. The microservices cluster, such as Elastic Container Service (ECS) is a cloud computing service in AWS that manages containers. It allows developers to run applications in the cloud without having to configure an environment for the code to run in.

According to some embodiments of the present disclosure, a secure, resizable compute in the cloud, such as Amazon Elastic Compute Cloud (EC2) may provide a secure, resizable compute capacity in the cloud.

According to some embodiments of the present disclosure, the WFM application, such as WFM application 130a in FIG. 1A, may be configured to update staffing level in the future staffing plan, based on the determined staffing-shrinkage percentage, e.g., the predicted staffing-shrinkage percentage determined by system 100A in FIG. 1A, and to store the updated future staffing plan in a WFM database, such as database service 185b.

FIG. 1C schematically illustrates a high-level diagram of a computerized-system 100C for predicting a staffing-shrinkage percentage in a time-slot during a future staffing plan in a contact center, in accordance with some embodiments of the present invention.

According to some embodiments of the present disclosure, system 100A in FIG. 1A may impact the following components of the WFM application, such as WFM application 130a in FIG. 1A.

According to some embodiments of the present disclosure, a forecaster microservice, such as forecaster service in FIG. 1B, may provide service to forecast interactions volume and Average Handle Time (AHT) for future dates and based on it generate staffing plans. It consumes historical data and then generates forecasting and staffing plan, provides historical data, forecasting and staffing plan chart data to the client. It also creates, edits, and views forecasting profiles, import staffing plan and special days if it is enabled. While setting forecasting parameter staffing-shrinkage via the WFM application, a system such as system 100A may collect historic data of agent time off and net staffing information. Additionally, Generative AI APIs may be utilized to prompt a user a human touch message which will help the user to understand the system better and set accurate staffing-shrinkage percentage per specific time-slot, such as per day and per interval, for example, as shown in FIG. 4A.

According to some embodiments of the present disclosure, the WFM application architecture may include the Schedule Manager which is the core application in the scheduling ecosystem. The Schedule Manager is storing and retrieving schedule data, net staffing data, and all configurations required to generate schedules including daily rules, weekly rules, and activity codes. It stores the shift trade configuration of the system.

According to some embodiments of the present disclosure, the WFM application architecture may further include Schedule Requests Manager (SRM) microservice. It manages all of the agent-generated Schedule Change Requests (SCRs). It provides adding/editing/getting/approving/declining SCRs. Upon new or edit the SCR, it is submitting calls the Schedule Rules Automation MS Validate API in order to validate the new or edited request against active auto approval rules. Submitting is disabled if there is a rule which auto declines the request. It calls the Schedule Manager service for saving the agent requests as new schedules e.g., overwrites the schedule, sends notifications to managers when requests are created and sends notifications to agents on approval or decline for their shift related request. The data is stored in Relational Database Service (RDS).

According to some embodiments of the present disclosure, The Real Time Analyst service is calculating the employees' adherence status by comparing the actual activity of the employee that is fetched from the ACD with the expected activity scheduled for the employee that is received by schedule-manager microservice. This service shows that the employee is in adherence or out of adherence.

According to some embodiments of the present disclosure, the Intraday Manager service is a microservice which is part of the WFM application, such as WFM application 130a in FIG. 1A. It shows all intraday metrics data e.g., actual, forecasted, variance, per one skill or multiple skills for 24-hour time-range. The forecasted data is compared with actual data and a variance is derived to get understanding of whether the contact center is understaffed or overstaffed. Intraday management is the process of monitoring current day's volumes and trends in the contact center.

According to some embodiments of the present disclosure, the Intraday service is implemented as a microservice, and it is part of the WFM application.

According to some embodiments of the present disclosure, the Intraday re-forecaster service may be configured to run every preconfigured period, e.g., every 15 minutes. It may be triggered by a Cron and starting two jobs. Get Forecast data e.g., AHT, ASA, Volume, SLA, Staffing, from schedule manager e.g., net-staffing API and saves it to Elastic Search(ES). Calculate Reforecast data e.g., AHT, ASA, Volume, SLA, for all tenants with reforecast toggle On, and save the results to ES. The forecast and reforecast data are presented by the Intraday manager.

According to some embodiments of the present disclosure, the Ingestor service, ACD-Ingestor microservice is responsible to ingest the ACD intraday data and metrics, which are consumed by intraday and a Performance Management (PM) application that is part of the WFM application. This microservice calls an API normalize and resolves the received data and sends it to a kinesis stream, when triggered by a spring Cron, e.g., every 15 min.

According to some embodiments of the present disclosure, the Time-Off Manager service enables the WFM manager to define Time-off rules, calculate time off balance for agents, and calculation API for automatic time off approval or semi-automatic approval.

According to some embodiments of the present disclosure, the shift Bidding Manager service may be implemented as a microservice and is part of the WFM application. It is responsible for managing agent bids for specific shifts that are made available for bidding. This microservice is managing the flows and the data related to Shift Bidding feature. Shift Bidding feature allows the tenant supervisor to define a few different weekly work schedules and open it for bidding for the agents of a selected schedule unit. Every agent that assigned to the selected schedule unit and assigned to any Shift-Bidding-Template, would enter to the generated bid. each agent would prioritize the weekly schedules. the assignment would happen by the agent's ranking.

According to some embodiments of the present disclosure, the Agent State Connector (ASC) microservice integrates between WFM Software as a Service (SaaS) Application and ACD Nodes agents OnPremise sends historical data, Intraday, Real Time Adherence (RTA) agents states events and lambdas that retrieve historical data. It also integrates between the WFM Software as a Service (Saas) Application and the UI, such as UI 150a in FIG. 1A, to import and clean historical data, e.g., in Comma-Separated Values (CSV) format.

According to some embodiments of the present disclosure, calls data include reports, such as historical data calls by skill, agent adherence and intraday skills data and RTS, ACD events.

According to some embodiments of the present disclosure, the WFM application, such as WFM application 130a in FIG. 1A, may be configured to update staffing level in the future staffing plan, based on the determined staffing-shrinkage percentage, e.g., the predicted staffing-shrinkage percentage determined by system 100A in FIG. 1A, and to store the updated future staffing plan in a WFM database, such as database service (not shown).

FIG. 2 schematically illustrates a high-level diagram of a computerized-method 200 for predicting a staffing-shrinkage percentage in a time-slot during a future staffing plan in a contact center, in accordance with some embodiments of the present invention.

According to some embodiments of the present disclosure, operation 210 comprising receiving via a User Interface that is associated to a Workforce Management (WFM) application, one or more skills for the future staffing plan and the time-slot.

According to some embodiments of the present disclosure, operation 220 comprising calculating a historic-shrinkage percentage during a preconfigured period based on agents' time-offs and understaffing-levels during the preconfigured period.

According to some embodiments of the present disclosure, operation 230 comprising determining the staffing-shrinkage percentage in the time-slot during the future staffing plan based on the calculated historic-shrinkage percentage.

According to some embodiments of the present disclosure, operation 240 comprising configuring the WFM application to update staffing level in the future staffing plan, based on the determined staffing-shrinkage percentage and store the updated future staffing plan in a WFM database.

FIG. 3A is a high-level workflow 300A of calculating historic shrinkage for predicting a staffing-shrinkage percentage in a time-slot during a future staffing plan, in accordance with some embodiments of the present invention.

According to some embodiments of the present disclosure, in system 100A in FIG. 1A the process of calculating historic shrinkage based on time-off reports and historic understaffing may begin by a user, such as a supervisor initiating a forecast generation. The user may input the required forecast parameters 305, which may include information related to staffing requirements and other relevant forecast parameters.

According to some embodiments of the present disclosure, while providing staffing parameters 310, fetching historic agent time-off reports 320 and historic net-staffing 315. A system, such as system 100A in FIG. 1A may fetch historic agent time-off information. This data may be retrieved from a table, such as SCHEDULE_CHANGE_REQUEST table, which contains records of agent time-off requests and approved time-off periods. For example, a Structured Query Language (SQL) query may be for example, select*from SCHEDULE_CHANGE_REQUEST where status=‘APPROVED’ AND start_date>selected_forecast_start_date AND end_date<selected_forecast_end_date.

According to some embodiments of the present disclosure, fetching net-staffing information may be operated simultaneously to the fetching of agent time-off reports. It may be fetched by system 100A in FIG. 1A from a table, such as STAFFING_DATA table. This table contains data related to staffing levels, including the number of available agents for specific skills at different times. For example, the SQL query may be, select*from STAFFING_DATA where start_date>selected_forecast_start_date AND end_date<selected_forecast_end_date.

According to some embodiments of the present disclosure, during a time-off information comparison, system 100A in FIG. 1A may filter agents with the selected skills 330 for the forecast generation. It may identify the number of agents per skill for a specific day or time slot based on the historic agent time-off information. The filtering of agents may be based on skills which are assigned to those agents. For example, the number of agents per skill, e.g., voice and chat, for a specific time slot may be calculated as follows:

RELEVANT_TIME_OFF_AGETNS=TOTAL_TIME_OFF_AGENTS−AGENTS_NOT_HAVING_SKILLS IN [Voice, Chat]

According to some embodiments of the present disclosure, for example, if there are 20 agents in the system which are assigned the skills voice and chat, while other 80 agents have different set of skills, and all these agents are supposed to work on a schedule with their assigned skill requirements, in the specific time slot, then the 20 agents are filtered from a total of 100 agents.

According to some embodiments of the present disclosure, the average of agents per skill for the specified time slot may be calculated by identifying the number of agents per skill for the specific time slot, e.g., day 340 and then calculating the average 345. This mean represents the typical staffing level for that skill during that time. For example, out of the 20 filtered agents, 10 agents took 2 hours of time-offs on the specific time slot, such as 12:00 AM through 08:00 AM, during the preconfigured period, then, when each time slot duration is 15 minutes and total time slots in a day of 24 hours is 96, in 2 hours the number of time offs is 8, so the total number of time slots is 8*10 agents=80. Then, the calculation for a selected day, such as Monday, as shown in FIG. 4A,

$$TOTAL\_SHRINKAGE \_ON \_MONDAY = ( TOTAL\_TIME \_OFF \_SLOTS / NUMBER\_OF \_ 15 MIN\_SLOTS \_IN \_A \_DAY * TOTAL\_NUMBER \_OF \_AGENTS ) ) * 100 = ( 80 / ( 96 * 20 ) * 100 = 4.16$$

According to some embodiments of the present disclosure, system 100A in FIG. 1A may operate a net-staffing information comparison by filtering net-staffing data for the selected skills 335. Then, it may calculate the understaffed time slots per skill for the specified time slot 355, indicating when the staffing level is below the desired threshold. For example, if there are 20 filtered agents for the skills voice and chat assigned to them, while the other 80 agents have different set of skills and all these agents are supposed to work on a schedule with their assigned skill requirements. A negative net-staffing may be calculated by comparing those agents which are categorized as understaffed agents. The number of understaffed time slots during that day will be averaged out 360.

According to some embodiments of the present disclosure, for example, during Monday, when understaffing occurred due to the filtered agents and contact center was understaffed by total 6 time slots on that day, then,

$$net\_staffing \_level \_shrinkage = ( TOTAL\_UNDERSTAND \_SLOTS / NUMBER\_OF \_ 15 MIN\_SLOTS \_IN \_A \_DAY ) * 100 = ( 6 / 96 ) * 100 = 6.25 \%$$

According to some embodiments of the present disclosure, the agent level shrinkage and the net-staffing level shrinkage average may be calculated 365. The calculating of the mean of agent-level shrinkage and net-staffing level shrinkage may be calculated for example, if calculated agent_level_shrinkage is 4.16% and net_staffing_level_shrinkage is 6.25%, then the average of 4.16% and 6.25% is 5.2%.

FIG. 3B is a high-level workflow 300B of calculating the staffing-shrinkage in predicting a staffing-shrinkage percentage in a time-slot during a future staffing plan, in accordance with some embodiments of the present invention.

According to some embodiments of the present disclosure, system 100A in FIG. 1A may derive the staffing-shrinkage percentage by calculating the mean of agent level shrinkage and net-staffing level shrinkage 370 and then calculate the per specific time period, such as day shrinkage percentage 375. This staffing-shrinkage percentage reflects the expected reduction in staffing availability, due to factors such as agent time-off and net-staffing variations.

According to some embodiments of the present disclosure, the derived staffing-shrinkage percent may be populated automatically into the shrinkage percentage field on the interface against respective days, for example, as shown in FIG. 4B.

According to some embodiments of the present disclosure, checking if the staffing-shrinkage has been automatically selected 380. If it was then staffing parameters may be automatically submitted 385 and the staffing level in the future staffing plan may be updated based on the determined staffing-shrinkage percentage.

According to some embodiments of the present disclosure, if the staffing-shrinkage is not automatically selected then an integration with GenAI user suggestion may be operated. The derived staffing-shrinkage percentage may be suggested to the user via the UI, such as UI 150a in FIG. 1A through integration with Generative AI (Gen AI). The Gen AI provides an intuitive prompt, as shown in FIG. 4A offering insights or suggestions related to optimizing staffing levels based on the calculated staffing-shrinkage percentage.

According to some embodiments of the present disclosure, the user may be provided an option to either submit the accurately predicted staffing-shrinkage automatically or put the percentage manually where Gen AI is utilized, and a message may be displayed to the user 395.

FIG. 4A is a screenshot of UI 400A for staffing staffing-shrinkage parameter of a WFM application, in accordance with some embodiments of the present invention.

According to some embodiments of the present disclosure, the UI 400A, such as UI 150a in FIG. 1A, may be implemented within an interactive computing environment, such as Jupyter that is often used for data analysis and machine learning tasks to interact with the Gen AI API. A prompt may be formulated within the Jupiter environment, that represents the input or query that is to be submitted to the Gen AI API. This prompt may be constructed based on the requirements of the task and the type of information needed from Gen AI.

According to some embodiments of the present disclosure, the formulated prompt may be sent to Gen AI API by making an API call from within the Jupyter notebook, specifying the necessary parameters, including the prompt itself. The Gen AI may process the received prompt and may generate a response. The processing involves leveraging machine learning models and algorithms to understand the context of the prompt and generate a meaningful and user-friendly output.

According to some embodiments of the present disclosure, the response generated by the Gen AI may be received back in the UI, such as Jupyter interface. The received response may be displayed within the UI. It may include textual information, visualizations, or any other relevant output generated by Gen AI based on the provided prompt. The interface may be a tool for formulating prompts and interacting with the Gen AI API. It may facilitate the process of sending queries to Gen AI, receiving user-friendly responses, and displaying the outcomes within the environment.

According to some embodiments of the present disclosure, the UI may provide a facility to either go with automatically calculated staffing-shrinkage or manually entering the staffing-shrinkage. If “Automatically” is selected, as shown in FIG. 4B, then staffing-shrinkage parameter may be submitted automatically to the WFM application which may be configured to update the staffing level in the specified time slot accordingly. Otherwise, an interface may be shown to the user, as shown in FIG. 4A, which may be the populated with the predicted staffing-shrinkage percentage. Optionally, after the UI is populated with the predicted staffing-shrinkage percentage, the user may manually override the predicted staffing-shrinkage percentage by entering a different shrinkage percentage.

According to some embodiments of the present disclosure, the interface for generating forecasts in the WFM application may include a pre-populated staffing shrinkage percentage for each specified time-slot. By hovering over an info icon, the GenAI may be triggered to display a message, such as “Based on historical data, it is anticipated that on Monday's first shift, there will be a 5% absence rate among employee, resulting in an expected shrinkage of 5%”.

According to some embodiments of the present disclosure, the staffing-shrinkage levels are crucial for accurate forecasting, and a system, such as system 100A in FIG. 1A may automate the process of populating it. Help text for user guidance, may be accompanying each weekday to help the user understand the populated staffing-shrinkage percentage.

According to some embodiments of the present disclosure, the predicted staffing-shrinkage percentage aims to optimize accuracy and efficiency in forecasting, by leveraging past patterns to inform future projections.

FIG. 5 is a high-level workflow 500 of interaction with GenAI for predicting a staffing-shrinkage percentage in a time-slot during a future staffing plan, in accordance with some embodiments of the present invention.

According to some embodiments of the present disclosure, to yield a message to the user to be presented via a UI that is associated to the WFM application, a Gen AI account should be set up and integrated with the system by establishing the necessary connections to access Gen AI APIs.

According to some embodiments of the present disclosure, input shrinkage percentage 510 may be operated by a user clicking on a shrinkage check box in a UI of the WFM application. This input may be used as the raw data to generate a prompt for Gen AI.

According to some embodiments of the present disclosure, the prompt generation for the GenAI may be operated by using shrinkage percentage and forming a prompt to get the result for selected shrinkage percentage 520. This prompt is the information or question posed to Gen AI, requesting a suggestion or solution based on the provided shrinkage data. For example, if the system, such as, system 100A in FIG. 1A, or the user inputs the staffing-shrinkage percentage as 5% against Monday then the system, such as system 100A in FIG. 1A may prepare this raw data as an input to the Gen AI as a prompt. For example, the prompt may be generated based on a template as follows: frame a sentence that tells the user that ‘Historical data suggests that on <param1> first shift, <param2>% of the employees will not show up. shrinkage of <param3>% needs to be added to overcome the understaffing’.

According to some embodiments of the present disclosure, this template will be used every time with different inputs based on what percentage Shrinkage is determined by a system, such as system 100A in FIG. 1A.

According to some embodiments of the present disclosure, for example, when staffing-shrinkage for Monday is 15%, then the prompt that may be generated may be ‘frame a sentence that tells the user that ‘Historical data suggests that on Monday first shift, 15% of the employees will not show up. shrinkage of 15% needs to be added to overcome the understaffing’.

According to some embodiments of the present disclosure, for example, when staffing-shrinkage for Friday is 20%, then the prompt that may be generated may be ‘frame a sentence that tells the user that ‘Historical data suggests that on Friday first shift, 20% of the employees will not show up. shrinkage of 20% needs to be added to overcome the understaffing’.

According to some embodiments of the present disclosure, the prompt may be passed as a parameter to the GenAI, for example, prompt=“frame a sentence that tells the user that ‘Historical data suggests that on Friday first shift, 20% of the employees will not show up. shrinkage of 20% needs to be added to overcome the understaffing”.

According to some embodiments of the present disclosure, use GenAI API key, such as OpenAI API key 530 for API call may be operated by utilizing a unique key when calling the Gen AI API. This key ensures authentication and authorization for accessing Gen AI services.

According to some embodiments of the present disclosure, interacting with the GenAI using AI library 540 by calling GenAI API with raw input, such as staffing-shrinkage percentage for real-time skills. This API call includes the unique key for identification and security purposes.

According to some embodiments of the present disclosure, using the generated prompt to call GenAI API 550 and consume the response from the GenAI 560. The Gen AI processes the raw input and, in return, provides a response. This response is an intuitive suggestion or solution generated by Gen AI based on its analysis of the Shrinkage percentage and other relevant factors. The response from Gen AI may be consumed 560, and the input prompt may generate output from Gen AI as a human touch text which may be for example,

“Based on historical data, it is anticipated that on Monday's first shift, there will be a 15% absence rate among employees, resulting in an expected shrinkage of 15%.” This text may be displayed to the user as it is as provided by Gen AI.

According to some embodiments of the present disclosure, a system, such as system 100A in FIG. 1A may consume the response received from Gen AI 560 and display the response via a dashboard 570. The intuitive suggestion generated by Gen AI may be displayed to the user. This information is presented through the interface used by the user, within the WFM application.

According to some embodiments of the present disclosure, the LLMs of the GenAI can comprehend and generate human language, making them valuable for tasks, such as text summarization, translation, and sentiment analysis. The LLMs can assist in generating coherent and contextually relevant content, which can be useful for content creation, creative writing, and various applications requiring natural language generation. The LLMs can also contribute to personalized content recommendations by understanding user preferences and generating content tailored to individual needs.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for predicting a staffing-shrinkage percentage in a time-slot during a future staffing plan in a contact center, said computerized-method comprising:
(i) receiving via a User Interface that is associated to a Workforce Management (WFM) application, one or more skills for the future staffing plan and the time-slot;
(ii) calculating a historic-shrinkage percentage during a preconfigured period based on agents' time-offs and understaffing-levels during the preconfigured period;
(iii) determining the staffing-shrinkage percentage in the time-slot during the future staffing plan based on the calculated historic-shrinkage percentage; and
(iv) configuring the WFM application to update staffing level in the future staffing plan, based on the determined staffing-shrinkage percentage and storing the updated future staffing plan in a WFM database.

2. The computerized-method of claim 1, wherein the calculating of the historic-shrinkage percentage during the preconfigured period comprising:
(i) calculating a staffing-shrinkage percentage of agents-level by:
a. retrieving agents time-offs during the preconfigured period from a schedule-change-request database;
b. filtering the retrieved agents time-offs based on the received one or more skills of corresponding agents and the time-off; and
c. calculating a mean of agents that took time-offs in the time-slot by identifying a total number of agents in the filtered agents time-offs and then dividing the identified total number of agents by a total number of time-slots in the filtered agents time-offs to yield an agent-level-shrinkage;
(ii) calculating a staffing-shrinkage percentage of net-staffing level by:
a. retrieving net-staffing data of a plurality of staffing plans during the preconfigured period, from a staffing-data database;
b. filtering the plurality of staffing plans based on the one or more skills of corresponding agents and understaffed time-slots in the time-slot; and
c. calculating a mean of understaffed time-slots by identifying a number of understaffed time-slots for the time-slot in the filtered plurality of staffing plans and then dividing a sum of understaffed-agents in all the identified number of understaffed time-slots by the total number of time-slots to yield a net-staffing-level-shrinkage; and
(iii) determining the historic-shrinkage percentage during the preconfigured period by calculating a mean of the agent-level-shrinkage and the net-staffing-level-shrinkage.

3. The computerized-method of claim 1, wherein the determined staffing-shrinkage percentage is presented as a message via the UI that is associated to the WFM application by operating a Generative Artificial Intelligence AI (GenAI) service with a prompt to yield the message.

4. The computerized-method of claim 3, wherein the operating of the GenAI service is performed by generating a prompt by embedding the determined staffing-shrinkage percentage in a prompt-template and then executing the GenAI with the prompt.

5. The computerized-method of claim 1, wherein the updating of the staffing level of the future staffing plan, based on the determined staffing-shrinkage percentage is performed by adding number of agents to the future staffing plan.

6. A computerized-system for predicting a staffing-shrinkage percentage in a time-slot during a future staffing plan in a contact center, said computerized-system comprising:
one or more processors, and a WFM database, said one or more processors are configured to:
(i) receive via a User Interface that is associated to a Workforce Management (WFM) application, one or more skills for the future staffing plan and the time-slot;
(ii) calculate a historic-shrinkage percentage during a preconfigured period based on agents' time-offs and understaffing-levels during the preconfigured period;
(iii) determine the staffing-shrinkage percentage in the time-slot during the future staffing plan based on the calculated historic-shrinkage percentage; and
(iv) configure the WFM application to update staffing level in the future staffing plan, based on the determined staffing-shrinkage percentage and store the updated future staffing plan in the WFM database.

7. The computerized-system of claim 6, wherein the calculating of the historic-shrinkage percentage during the preconfigured period comprising:
(i) calculating a staffing-shrinkage percentage of agents-level by:
a. retrieving agents time-offs during the preconfigured period from a schedule-change-request database;
b. filtering the retrieved agents time-offs based on the received one or more skills of corresponding agents and the time-off; and
c. calculating a mean of agents that took time-offs in the time-slot by identifying a total number of agents in the filtered agents time-offs and then dividing the identified total number of agents by a total number of time-slots in the filtered agents time-offs to yield an agent-level-shrinkage;
(ii) calculating a staffing-shrinkage percentage of net-staffing level by:
a. retrieving net-staffing data of a plurality of staffing plans during the preconfigured period, from a staffing-data database;
b. filtering the plurality of staffing plans based on the one or more skills of corresponding agents and understaffed time-slots in the time-slot; and
c. calculating a mean of understaffed time-slots by identifying a number of understaffed time-slots for the time-slot in the filtered plurality of staffing plans and then dividing a sum of understaffed-agents in all the identified number of understaffed time-slots by the total number of time-slots to yield a net-staffing-level-shrinkage; and
(iii) determining the historic-shrinkage percentage during the preconfigured period by calculating a mean of the agent-level-shrinkage and the net-staffing-level-shrinkage.

8. The computerized-system of claim 6, wherein the determined staffing-shrinkage percentage is presented as a message via the UI that is associated to the WFM application by operating a Generative Artificial Intelligence AI (GenAI) service with a prompt to yield the message.

9. The computerized-system of claim 8, wherein the operating of the GenAI service is performed by generating a prompt by embedding the determined staffing-shrinkage percentage in a prompt-template and then executing the GenAI with the prompt.

10. The computerized-system of claim 6, wherein the updating of the staffing level of the future staffing plan, based on the determined staffing-shrinkage percentage is performed by adding number of agents to the future staffing plan.
